(19) United States
(12) Patent Application Publication
(10) Pub. No.: US 2014/0359408 A1
(43) Pub. Date: Dec. 4, 2014

(54) Invoking an Application from a Web Page or other Application

(71) Applicant: Microsoft Corporation, Redmond, WA (US)

(72) Inventor: Jonathan David Rosenberg, Freehold, NJ (US)

(21) Appl. No.: 13/909,719

(22) Filed: Jun. 4, 2013

(51) Int. Cl. G06F 17/22

(52) U.S. Cl. CPC G06F 17/2235
USPC 715/205

(57) ABSTRACT

Various embodiments provide an application (i.e. “app”) hyperlink that is configured to enable transparent installation of an associated application. The app hyperlink provides a visual representation that can be selected to cause a web platform or operating system to download an application image from a platform app store, install the application, provide the user with visual feedback on the process, and once done, invoke the application by performing an “app switch” or similar operation.

### BACKGROUND

Today, the web provides a very simple model for moving from web page to web page, through the use of hyperlinks. When a user clicks on a hyperlink, the browser automatically fetches new content and renders it for the user. This content can include anything from a simple web page to a full-fledged application, like Gmail or Outlook.

On mobile clients and modern operating systems, the industry is seeing a surge in the use of applications (aka “apps”) instead of web pages. However, apps lack some of the key features that web pages have. In particular, apps lack the concept of a hyperlink.

### SUMMARY

This Summary is provided to introduce a selection of concepts in a simplified form that are further described below in the Detailed Description. This Summary is not intended to identify key features or essential features of the claimed subject matter.

Various embodiments provide an application (i.e. “app”) hyperlink. The app hyperlink is configured to enable transparent installation of an associated application.

In one or more embodiments an app hyperlink is a small embeddable piece of code that a website developer or app developer can include in their site or application. The app hyperlink is rendered by a web platform, such as a web browser, or operating system, to provide a visual representation to the user of the result of selecting, e.g., clicking or touching this app hyperlink. When the user selects the app hyperlink, the browser or operating system will download the application image from a platform app store, install the application, provide the user with visual feedback on the process, and once done, invoke the application by performing an “app switch” or similar operation.

In at least some embodiments, though technically the app is now “installed” on the user's system, there is no icon left on the user's start menu or home screen. Consequently, if the user exits the application, there is no visible trace left to the user. The user can, of course, visit the app store on the platform, search for the app, find it, and opt to “install” it. In such a case, if the cached app image is still current, the download and install process can be skipped, and instead the icon for the app is only then placed on the user's home screen.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation in accordance with one or more embodiments.

FIG. 2 is an illustration of a system in an example implementation showing FIG. 1 in greater detail.

FIG. 3 illustrates an example system architecture in accordance with one or more embodiments.

FIG. 4 illustrates an example user interface in accordance with one or more embodiments.

FIG. 5 illustrates an example user interface in accordance with one or more embodiments.

FIG. 6 is a flow diagram that describes steps in a method in accordance with one or more embodiments.

FIG. 7 illustrates an example computing device that can be utilized to implement various embodiments described herein.

### DETAILED DESCRIPTION

Overview

Today, it is not currently possible for a user, while visiting one app (or a website), to click on a link, and with just one click, cause an app to be automatically fetched from an app store, downloaded, installed and then invoked. While modern operating systems do provide app URLs, these URLs typically bring the user to the app store, requiring them to still click on “install”, and then once again click to launch the application. These additional clicks represent friction to moving seamlessly between apps. Furthermore, installing an app from the app store typically leaves an icon on the user's start screen, thus requiring—in essence—a level of commitment or permanence.

Hyperlinks, on the other hand, allow a user to move from site to site, and there is no permanence to the visits. While the user may bookmark a site, and the content might be cached, there is no permanent impact to visiting the site.

Consequently, without the concept of hyperlinking, movement between applications is difficult, and the power of hyperlinks on the web as a means of quickly moving from content to content, of sharing content, and of virally spreading content, are missing from the app ecosystem.

Various embodiments provide an application (i.e. “app”) hyperlink. The app hyperlink is configured to enable transparent installation and execution of an associated application.

In one or more embodiments an app hyperlink is a small embeddable piece of code that a website developer or app developer can include in their site or application. The app hyperlink is rendered by a web platform, such as a web browser, or operating system, to provide a visual representation to the user of the result of selecting, e.g., clicking or touching this app hyperlink. When the user selects the app hyperlink, the browser or operating system will download the application image from a platform app store, install the application, provide the user with visual feedback on the process, and once done, invoke the application by performing an “app switch” or similar operation.

In at least some embodiments, though technically the app is now “installed” on the user's system, there is no icon left on the user's start menu or home screen. Consequently, if the user exits the application, there is no visible trace left to the user. The user can, of course, subsequently visit the app store on the platform, search for the app, find it, and opt to “install” it. In such a case, if the cached app image is still current, the download and install process can be skipped, and instead the icon for the app is only then placed on the user's home screen.

A web platform, as referenced above, is a platform that works in connection with content of the web, e.g. public content. A web platform can include and make use of many different types of technologies such as, by way of example and not limitation, URLs, HTTP, REST, HTML, CSS, JavaScript, DOM, as well as other technologies. The web platform can also work with a variety of data formats such as XML, JSON, and the like. Web platforms can include web browsers, local applications such as Windows® Store applications that can be installed and executed on a user's local computing device, and the like.

In the following discussion, an example environment is first described that is operable to employ the techniques described herein. Example illustrations of the various embodiments are then described, which may be employed in the example environment, as well as in other environments. Accordingly, the example environment is not limited to performing the described embodiments and the described embodiments are not limited to implementation in the example environment.

Example Operating Environment

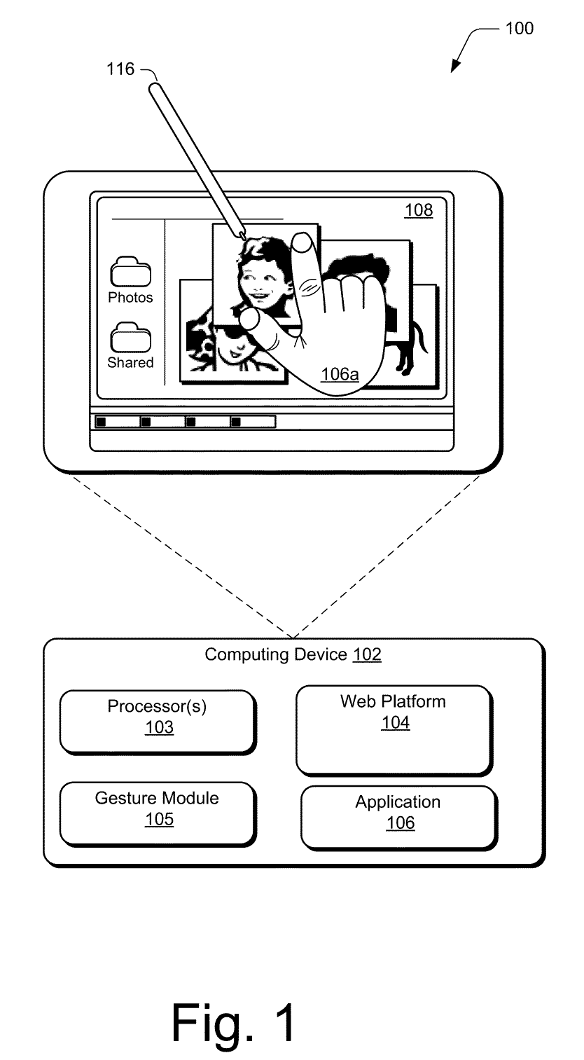

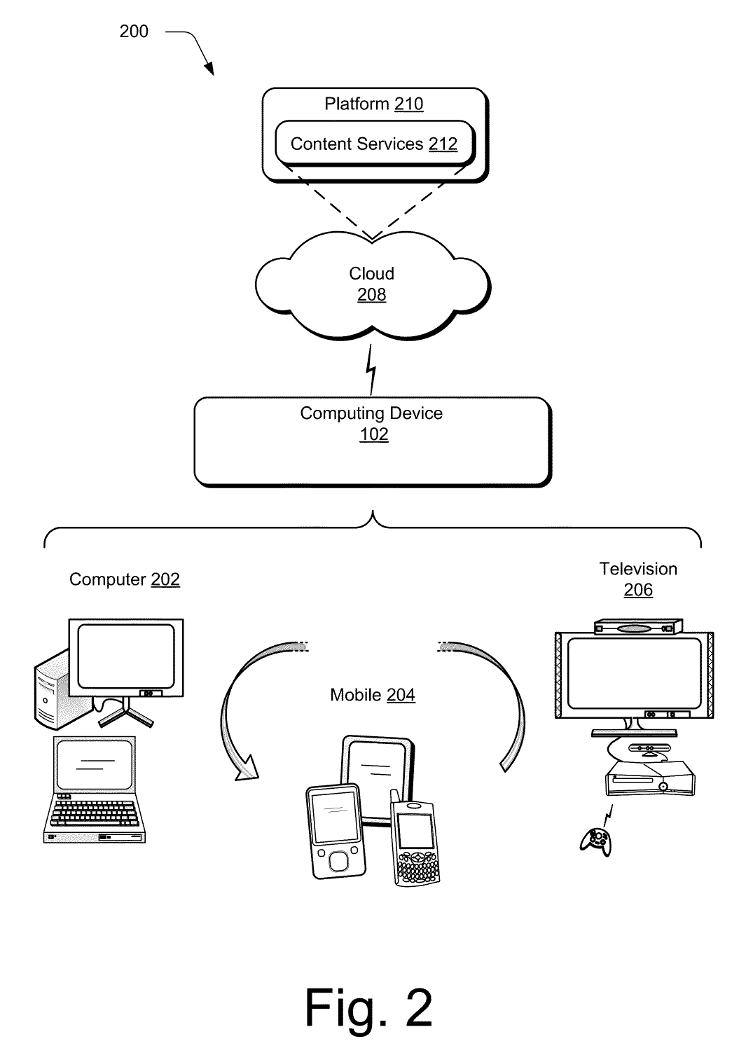

FIG. 1 is an illustration of an environment 100 in an example implementation that is operable to employ the techniques described in this document. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device, and so forth as further described in relation to FIG. 2. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 also includes software that causes the computing device 102 to perform one or more operations as described below.

Computing device 102 also includes a web platform 104. As noted above, the web platform works in connection with content of the web, e.g. public content such as web pages and the like. A web platform can include and make use of many different types of technologies such as, by way of example and not limitation, URLs, HTTP, REST, HTML, CSS, JavaScript, DOM, and the like. The web platform can also work with a variety of data formats such as XML, JSON, and the like. Web platforms can include web browsers, local applications such as a Windows® Store application, and the like.

Computing device 102 also includes a gesture module 105 that recognizes input pointer gestures that can be performed by one or more fingers, and causes operations or actions to be performed that correspond to the gestures. The gestures may be recognized by module 105 in a variety of different ways. For example, the gesture module 105 may be configured to recognize a touch input, such as a finger of a user's hand 106a as proximal to display device 108 of the computing device 102 using touchscreen functionality, or functionality that senses proximity of a user's finger that may not necessarily be physically touching the display device 108, e.g., using near field technology. Module 105 can be utilized to recognize single-finger gestures and bezel gestures, multiple-finger/same-hand gestures and bezel gestures, and/or multiple-finger/different-hand gestures and bezel gestures.

Computing device 102 also includes one or more applications 106 that can be invoked to execute on the computing device. Any suitable type of applications can be provided. These applications can include an application hyperlink that enables an additional application to be invoked. The app hyperlink is configured to enable transparent installation of an associated application.

In one or more embodiments an app hyperlink is a small embeddable piece of code that a website developer or app developer can include in their site or application. The app hyperlink can be rendered by web platform 104, such as a web browser, or operating system, to provide a visual representation to the user of the result of selecting, e.g., clicking or touching this app hyperlink. When the user selects the app hyperlink, the browser or operating system will download the application image from a platform app store, install the application, provide the user with visual feedback on the process, and once done, invoke the application by performing an “app switch” or similar operation.

In at least some embodiments, though technically the app is now “installed” on the user's system, there is no icon left on the user's start menu or home screen. Consequently, if the user exits the application, there is no visible trace left to the user. The user can, of course, visit the app store on the platform, search for the app, find it, and opt to “install” it. In such a case, if the cached app image is still current, the download and install process can be skipped, and instead the icon for the app is only then placed on the user's home screen.

Thus, the app hyperlink can be utilized in connection with one or more of the following features.
The operating system or web browser can render an image or icon associated with the app hyperlink which is selectable to enable transparent installation and launching of an app.
The image or icon associated with the app can be obtained by having the web browser or operating system transact with an appropriate app store in the cloud, thus retrieving an image appropriate for the app.
The image or icon can include content from the app provider such as, for example, an image associated with functionality provided by the app.
The operating system or the web browser can automatically download and install the app when the app hyperlink is clicked, without having the user to navigate to the app store only to be taken through a progressive user interface experience where they must selectively click through the various options in order to obtain an app.
The app can be automatically downloaded and installed without placing visual indicia, e.g. a tile or icon, on the user's start screen or taskbar.
The downloaded app can be cached so that the process might be avoided next time the user selects the app by, for example, selecting the app at an app store.
The cached app version can be checked for obsolescence by querying an app store service. If the app is obsolete, a current version of the app can be provided to the user's device.

The computing device 102 may also be configured to detect and differentiate between a touch input (e.g., provided by one or more fingers of the user's hand 106a) and a stylus input (e.g., provided by a stylus 116). The differentiation may be performed in a variety of ways, such as by detecting an amount of the display device 108 that is contacted by the finger of the user's hand 106a versus an amount of the display device 108 that is contacted by the stylus 116.

Thus, the gesture module 105 may support a variety of different gesture techniques through recognition and leverage of a division between stylus and touch inputs, as well as different types of touch inputs and non-touch inputs.

FIG. 2 illustrates an example system 200 that includes the computing device 102 as described with reference to FIG. 1. The example system 200 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 200, multiple devices are interconnected through a central computing device. The central computing device may be local to the multiple devices or may be located remotely from the multiple devices. In one embodiment, the central computing device may be a cloud of one or more server computers. These computers can be connected to the multiple devices through a network, the Internet, or other data communication link. In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 102 may assume a variety of different configurations, such as for computer 202, mobile 204, and television 206 uses. Each of these configurations includes devices that may have generally different constructs and capabilities, and thus the computing device 102 may be configured according to one or more of the different device classes. For instance, the computing device 102 may be implemented as the computer 202 class of a device that includes a personal computer, desktop computer, a multi-screen computer, laptop computer, netbook, and so on. Each of these different configurations may employ a web platform, e.g. a web browser, as described above and below.

The computing device 102 may also be implemented as the mobile 204 class of device that includes mobile devices, such as a mobile phone, portable music player, portable gaming device, a tablet computer, a multi-screen computer, and so on. The computing device 102 may also be implemented as the television 206 class of device that includes devices having or connected to generally larger screens in casual viewing environments. These devices include televisions, set-top boxes, gaming consoles, and so on. The techniques described herein may be supported by these various configurations of the computing device 102 and are not limited to the specific examples the techniques described herein.

The cloud 208 includes and/or is representative of a platform 210 for content services 212. The platform 210 abstracts underlying functionality of hardware (e.g., servers) and software resources of the cloud 208. The content services 212 may include applications and/or data that can be utilized while computer processing is executed on servers that are remote from the computing device 102. Content services 212 can be provided as a service over the Internet and/or through a subscriber network, such as a cellular or Wi-Fi network.

The platform 210 may abstract resources and functions to connect the computing device 102 with other computing devices. The platform 210 may also serve to abstract scaling of resources to provide a corresponding level of scale to encountered demand for the content services 212 that are implemented via the platform 210. Accordingly, in an interconnected device embodiment, implementation of functionality described herein may be distributed throughout the system 200. For example, the functionality may be implemented in part on the computing device 102 as well as via the platform 210 that abstracts the functionality of the cloud 208.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable memory devices. The features of the gesture techniques described below are platform-independent, meaning that the techniques may be implemented on a variety of commercial computing platforms having a variety of processors.

In the discussion that follows, various sections describe various example embodiments. A section entitled “Example Architecture” describes an example architecture in accordance with one or more embodiments. Next, a section entitled “Example Method” describes an example method in accordance with one or more embodiments. Last, a section entitled “Example Device” describes aspects of an example device that can be utilized to implement one or more embodiments.

Having described example operating environments in which the inventive principles can be employed, consider now a discussion of various embodiments.

Example Architecture

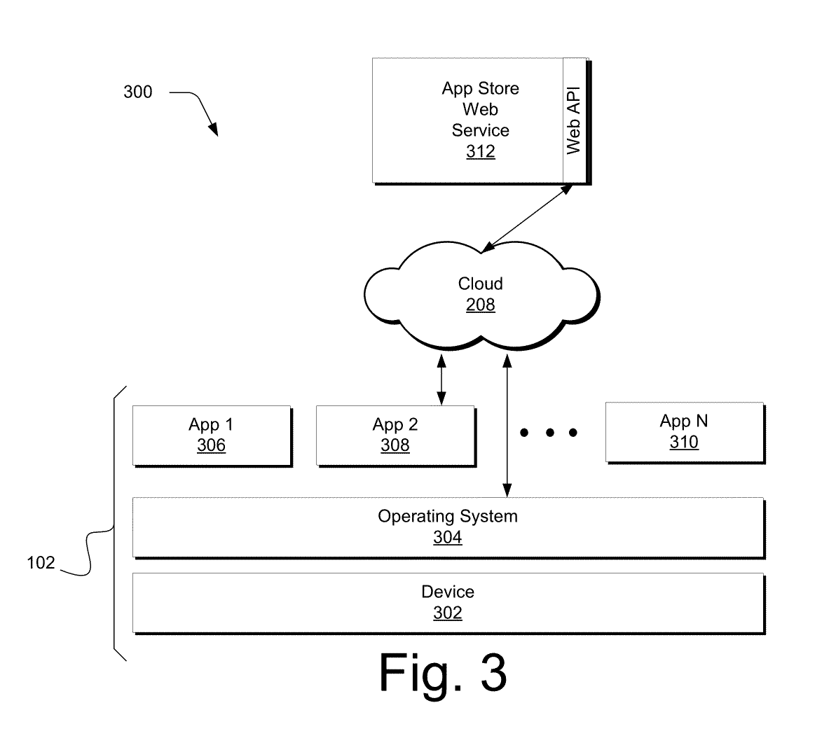

FIG. 3 illustrates an example system architecture in accordance with one or more embodiments generally at 300. In this example, the architecture includes the computing device 102 such as that described above. The computing device includes device hardware 302, an operating system 304, and various applications or apps 306, 308, 310. The applications can include a web platform such as a web browser. The architecture also includes a cloud 208, such as the Internet and an app store web service 312 that includes a web API that can be called by the operating system 304 and/or one or more of apps 306, 308, and 310, as described in detail just below.

In the illustrated and described example, the operating system 304 and/or applications 306, 308, and 310 serve as execution environments in which additional applications can be invoked.

Assume now that an application is running within the operating system 304. The application may access an API, such as the Web API, which causes the operating system 304 to render a visual link within the application. Consider, for example, an application written in HTML5. This application might include a reference such as:

<a href=“applink:skype?userid=Xam” size=“100×100”/>

This reference embeds a hyperlink in the application. This hyperlink can manifest in any suitable way. For example, the hyperlink can manifest within the application's user interface as a clickable 100×100 pixel button. When the operating system or web browser encounters this reference, it can access the app store web service 312 through the Web API. The web API exposed by the app store web service 312 allows the operating system or browser to query for an image to render.

For example, the app store API could take the form:

http://appstore.operating-system.com/geticon/skype?userID&size=100×100

This asks the app store web service 312 to validate that “skype” is a valid app, and to fetch the icon appropriate for the applink URI skype?userid=Xam. The app store web service 312 will validate that the app exists and is supported as a free application on the associated platform. In this particular example, to ascertain which icon to render, it will combine its own icon for Skype (the Skype logo) with additional image content obtained from Skype's own web services. To do that, the app store web service 312 invokes a Skype web service. This web service can be registered with the app store as part of the process of submitting the app. The Skype web service, in turn, takes the parameter (userid=Xam) and obtains a profile picture for Xam, and returns it to the web store app service 312. The web store app service 312 combines this with the icon it has for the application (e.g., the Skype logo), and returns the combined set to the operating system 304 or browser.

In one or more embodiments, the icon for the app itself is provided by the app store, and not the Skype web service, in order to provide a degree of trust. This is because the operating system trusts the app store web service 312.

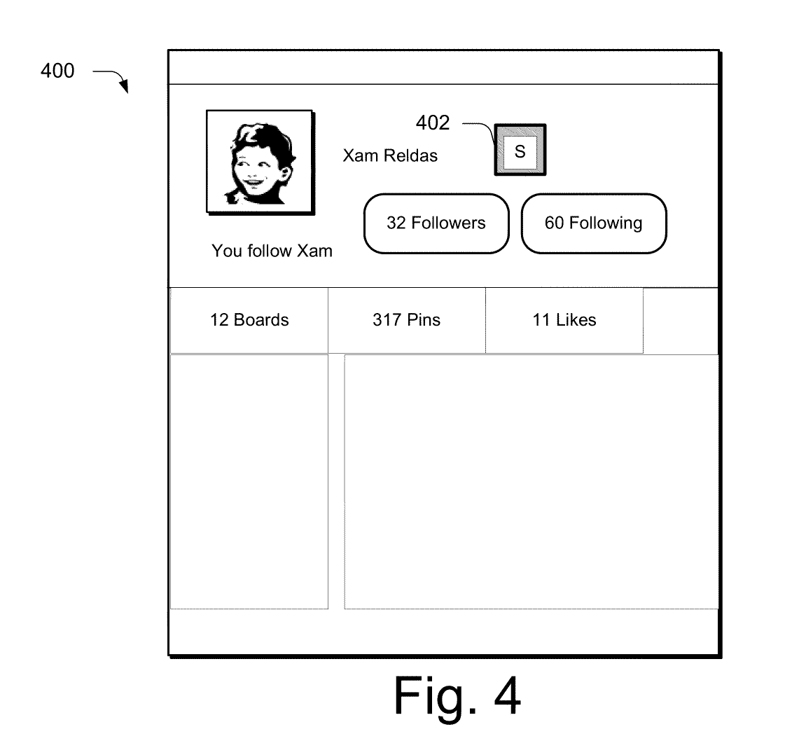

Once the operating system receives the icon, the operating system renders the icon in the application's user interface. As an example, consider FIG. 4.

There, a user interface for a social networking application is shown generally at 400. In this particular instance, the user is following an individual named “Xam Reldas”. In this case, the application or operating system has queried the app store web service 312 and received icon 402 which is associated with a different application—in this example, a communication application offered by Skype. The communication application enables individuals to place calls over a network such as the Internet. The web service 312 also returned a profile picture for Xam.

Now, if the user clicks on or otherwise selects the icon 402, the operating system will invoke another web service on the app store, this time requesting download of the app package associated with the icon 402. If the app has not been previously installed, the app store web service returns an application package to the operating system. If, on the other hand, the app has been previously installed, the operating system can include, in this request, a version number for the currently cached app image. When the app store web service receives this request, if a version number is included, the app store web service checks the version number, and if it is older than the most recent version number, the app store web service returns the most recent app package to the operating system. Otherwise, it returns a response saying the currently cached version is valid. This can be done using normal http cache control headers, or web service specific parameters. In one or more embodiments, during the process of downloading the app package, the operating system can update the icon for the app to provide a progress bar on download/install.

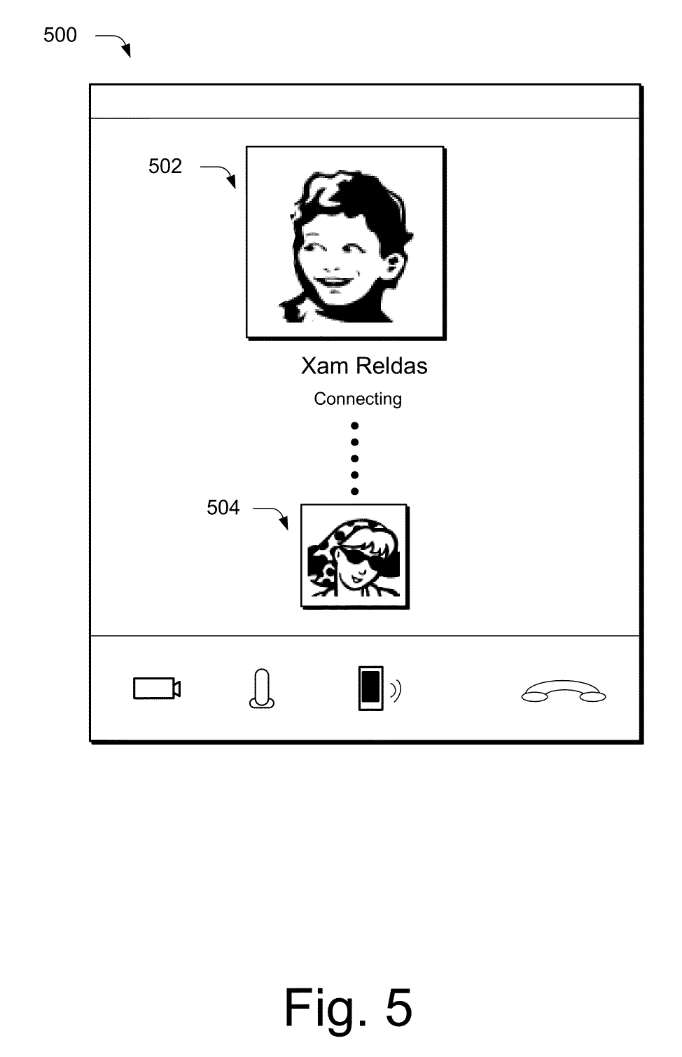

Once the app package is downloaded, the operating system installs the app package. In one or more embodiments, the operating system does not place an icon for the app onto the user's home/start screen. The operating system can now switch to that app, using any suitable app switching technique. To provide context to the newly-installed app, a URL can be passed to the app when invoking it. In this particular example, the operating system can provide the Skype app with the userID of the party to call—in this case Xam. As an example, consider FIG. 5.

There, a user interface of the newly installed app is shown generally at 500. In this particular instance, a call is being placed to Xam and Xam's previously-acquired profile picture is shown at 502. The calling party's picture is shown at 504.

The URL can also enable different ways of invoking the app. For example, in some operating systems, an URL parameter can be used to indicate that the app is to be started in a particular mode, e.g., snap mode (left or right) or full screen mode. There could alternatively be URL parameters which specify embedding the app's user interface within the invoking app, thereby enabling embedded experiences.

Having discussed various embodiments, consider now an example method in accordance with one or more embodiments.

Example Method

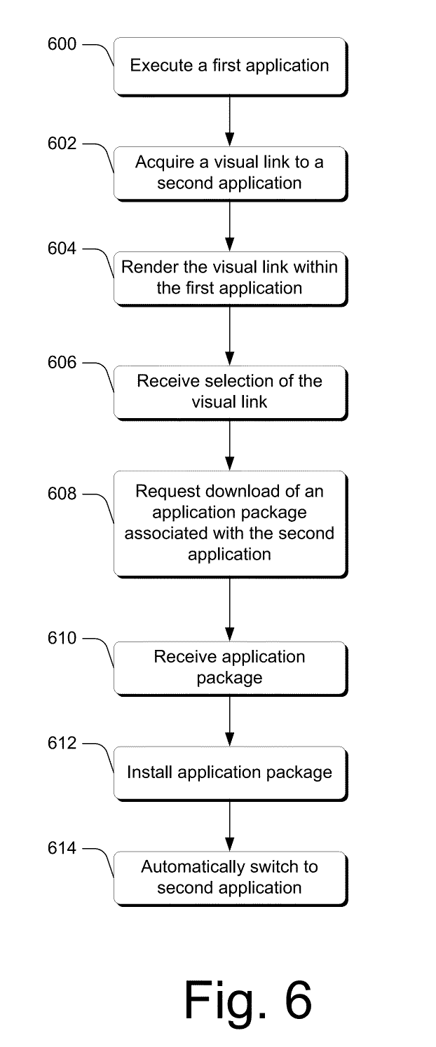

FIG. 6 is a flow diagram that describes steps in a method in accordance with one or more embodiments. The method can be implemented in connection with any suitable hardware, software, firmware, or combination thereof. In at least some embodiments, the method can be implemented by a suitably-configured operating system, application, web platform, or web browser.

Step 600 executes a first application. This step can be performed in any suitable way and can include any suitably-configured application. Step 602 acquires a visual link to a second application. This step can be performed in any suitable way. For example, this step can be performed by calling a suitably-configured API an example of which is provided above. Step 604 renders the visual link within the first application. An example of how this can be done is provided above.

Step 606 receives selection of the visual link. This step can be performed in any suitable way. For example, in at least some embodiments the visual link can be touched-selected in touch-enabled devices. Alternately or additionally, the visual link can be selected with an input mechanism such as a mouse, stylus, and the like. Alternately or additionally, the visual link can be selected by way of a natural user interface (NUI). Responsive to receiving selection of the visual link, step 608 requests download of an application package associated with the second application. This step can be performed in various ways. For example, if the second application has been previously installed, the request can include a version number, as described above, to ascertain whether the installed second application is the most recent. If the second application has not been previously installed, the generated request would simply request an application package associated with the second application.

Step 610 receives the application package and step 612 installs the application package on the user's computing device. Step 614 automatically switches to the second application from the first application. This step can be performed in any suitable way.

Having considered various embodiments, consider now a discussion of example device that can be utilized to implement the embodiments described above.

Example Device

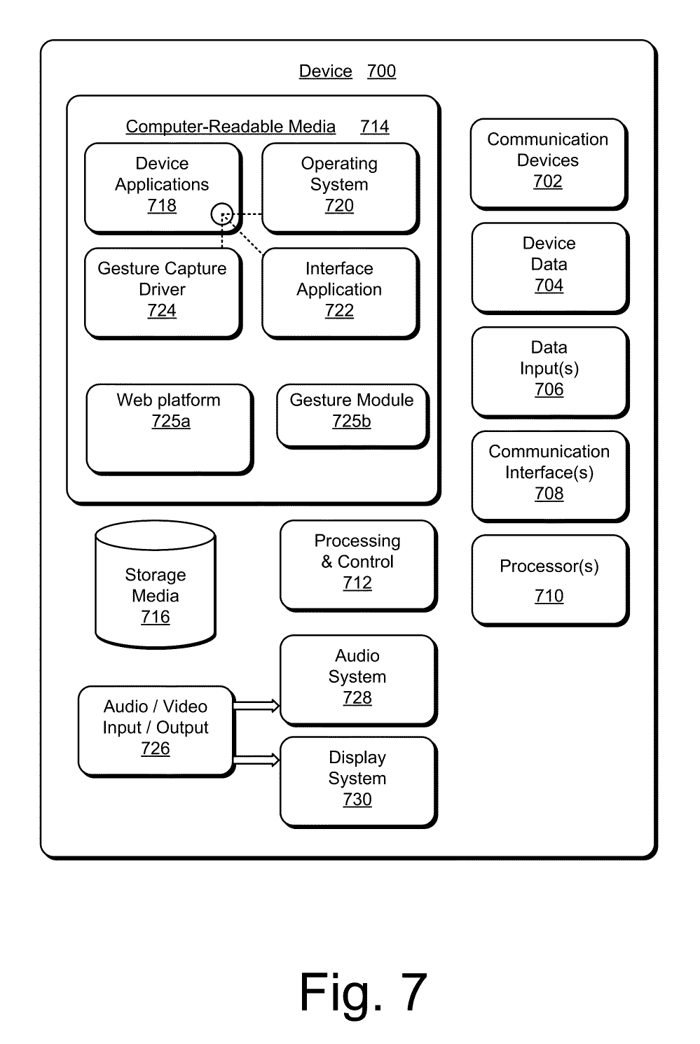

FIG. 7 illustrates various components of an example device 700 that can be implemented as any type of portable and/or computer device as described with reference to FIGS. 1 and 2 to implement embodiments of the animation library described herein. Device 700 includes communication devices 702 that enable wired and/or wireless communication of device data 704 (e.g., received data, data that is being received, data scheduled for broadcast, data packets of the data, etc.). The device data 704 or other device content can include configuration settings of the device, media content stored on the device, and/or information associated with a user of the device. Media content stored on device 700 can include any type of audio, video, and/or image data. Device 700 includes one or more data inputs 706 via which any type of data, media content, and/or inputs can be received, such as user-selectable inputs, messages, music, television media content, recorded video content, and any other type of audio, video, and/or image data received from any content and/or data source.

Device 700 also includes communication interfaces 708 that can be implemented as any one or more of a serial and/or parallel interface, a wireless interface, any type of network interface, a modem, and as any other type of communication interface. The communication interfaces 708 provide a connection and/or communication links between device 700 and a communication network by which other electronic, computing, and communication devices communicate data with device 700.

Device 700 includes one or more processors 710 (e.g., any of microprocessors, controllers, and the like) which process various computer-executable or readable instructions to control the operation of device 700 and to implement the embodiments described above. Alternatively or in addition, device 700 can be implemented with any one or combination of hardware, firmware, or fixed logic circuitry that is implemented in connection with processing and control circuits which are generally identified at 712. Although not shown, device 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 700 also includes computer-readable media 714, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 700 can also include a mass storage media device 716.

Computer-readable media 714 provides data storage mechanisms to store the device data 704, as well as various device applications 718 and any other types of information and/or data related to operational aspects of device 700. For example, an operating system 720 can be maintained as a computer application with the computer-readable media 714 and executed on processors 710. The device applications 718 can include a device manager (e.g., a control application, software application, signal processing and control module, code that is native to a particular device, a hardware abstraction layer for a particular device, etc.), as well as other applications that can include, web browsers, image processing applications, communication applications such as instant messaging applications, word processing applications and a variety of other different applications. The device applications 718 also include any system components or modules to implement embodiments of the techniques described herein. In this example, the device applications 718 include an interface application 722 and a gesture-capture driver 724 that are shown as software modules and/or computer applications. The gesture-capture driver 724 is representative of software that is used to provide an interface with a device configured to capture a gesture, such as a touchscreen, track pad, camera, and so on. Alternatively or in addition, the interface application 722 and the gesture-capture driver 724 can be implemented as hardware, software, firmware, or any combination thereof. In addition, computer readable media 714 can include a web platform 725a and a gesture module 725b that functions as described above.

Device 700 also includes an audio and/or video input-output system 726 that provides audio data to an audio system 728 and/or provides video data to a display system 730. The audio system 728 and/or the display system 730 can include any devices that process, display, and/or otherwise render audio, video, and image data. Video signals and audio signals can be communicated from device 700 to an audio device and/or to a display device via an RF (radio frequency) link, S-video link, composite video link, component video link, DVI (digital video interface), analog audio connection, or other similar communication link. In an embodiment, the audio system 728 and/or the display system 730 are implemented as external components to device 700. Alternatively, the audio system 728 and/or the display system 730 are implemented as integrated components of example device 700.

### CONCLUSION

Various embodiments provide an application (i.e. “app”) hyperlink. The app hyperlink is configured to enable transparent installation of an associated application.

In one or more embodiments an app hyperlink is a small embeddable piece of code that a website developer or app developer can include in their site or application. The app hyperlink is rendered by a web platform, such as a web browser, or operating system, to provide a visual representation to the user of the result of selecting, e.g., clicking or touching this app hyperlink. When the user selects the app hyperlink, the browser or operating system will download the application image from a platform app store, install the application, provide the user with visual feedback on the process, and once done, invoke the application by performing an “app switch” or similar operation.

Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A computer-implemented method comprising:
executing a first application on a computing device;
acquiring a visual link to a second application;
rendering the visual link within the first application;
receiving selection of the visual link;
responsive to receiving selection of the visual link, requesting download of an application package associated with the second application;
receiving the application package;
installing the application package on the computing device; and
automatically switching to the second application from the first application.

2. The computer-implemented method of claim 1, wherein said requesting comprises including a version number of a previously-installed version of the second application.

3. The computer-implemented method of claim 1, wherein said requesting comprises including a version number of a previously-installed version of the second application.

4. The computer-implemented method of claim 1, wherein acts of acquiring, rendering, receiving selection, requesting, receiving the application package, installing, and automatically switching are performed by an operating system.

5. The computer-implemented method of claim 1, wherein acts of acquiring, rendering, receiving selection, requesting, receiving the application package, installing, and automatically switching are performed by software other than an operating system.

6. The computer-implemented method of claim 1, wherein said installing is performed without placing visual indicia of the second application on the computing device's start screen or taskbar.

7. The computer-implemented method of claim 1, wherein said requesting comprises requesting download of the application package from an app store.

8. The computer-implemented method of claim 1, wherein said receiving the application package and installing the application package is performed without having an associated user navigate to an associated app store from which the second application is obtained.

9. The computer-implemented method of claim 1, wherein the second application comprises a communication application that enables individuals to place calls over a network.

10. One or more computer readable storage memories embodying computer readable instructions which, when executed, implement a method comprising:
executing a first application on a computing device;
acquiring a visual link to a second application;
rendering the visual link within the first application;
receiving selection of the visual link;
responsive to receiving selection of the visual link, requesting download of an application package associated with the second application;
receiving the application package;
installing the application package on the computing device; and
automatically switching to the second application from the first application,
wherein:
said receiving the application package and installing the application package is performed without having an associated user navigate to an associated app store from which the second application is obtained; and
said second application comprises a communication application that enables individuals to place calls over a network.

11. The one or more computer readable storage media of claim 10, wherein said requesting comprises including a version number of a previously-installed version of the second application.

12. The one or more computer readable storage media of claim 10, wherein acts of acquiring, rendering, receiving selection, requesting, receiving the application package, installing, and automatically switching are performed by an operating system.

13. The one or more computer readable storage media of claim 10, wherein acts of acquiring, rendering, receiving selection, requesting, receiving the application package, installing, and automatically switching are performed by software other than an operating system.

14. The one or more computer readable storage media of claim 10, wherein said installing is performed without placing visual indicia of the second application on the computing device's start screen or taskbar.

15. The one or more computer readable storage media of claim 10, wherein said requesting comprises requesting download of the application package from an app store.

16. A computing device comprising:
one or more processors;
one or more computer readable storage media;
instructions embodied on the one or more computer readable storage media which, when executed, implement a method comprising:
executing a first application on the computing device;
acquiring a visual link to a second application;
rendering the visual link within the first application;
receiving selection of the visual link;
responsive to receiving selection of the visual link, requesting download of an application package associated with the second application;
receiving the application package;
installing the application package on the computing device; and
automatically switching to the second application from the first application.

17. The computing device of claim 16, wherein said installing is performed without placing visual indicia of the second application on the computing device's start screen or taskbar.

18. The computing device of claim 16, wherein said receiving the application package and installing the application package is performed without having an associated user navigate to an associated app store from which the second application is obtained.

19. The computing device of claim 16, wherein the second application comprises a communication application that enables individuals to place calls over a network

20. The computing device of claim 16, wherein acts of acquiring, rendering, receiving selection, requesting, receiving the application package, installing, and automatically switching are performed by an operating system.
